(19) United States
(12) Patent Application Publication
(10) Pub. No.: US 2002/0116527 A1
(43) Pub. Date: Aug. 22, 2002

(54) Lookup engine for network devices

(76) Inventors: Jin-Ru Chen, Taichung (CN); Yao-Tzung Wang, HsinChu (TW)

Correspondence Address: BIRCH STEWART KOLASCH & BIRCH, PO BOX 747, FALLS CHURCH, VA, 22040-0747, US

(21) Appl. No.: 09/740,819

(22) Filed: Dec. 21, 2000

(51) Int. Cl. G06F 15/16

(52) U.S. Cl. 709/245

(57) ABSTRACT

A lookup engine for a network device is provided to lookup an address table. The lookup engine includes a parser for getting address information of an incoming packet. A predetermined number of shift control logic is provided for generating an I.I.D hash index for the incoming packet in response to the address information of the incoming packet. The output of each shift control logic is selected by a selector for looking up an address table, thereby to generate a forwarding information. With the implementation of the shift control logic, the lookup engine can construct each flow entry and classify the incoming packets belonging to this flow in wire-speed.

### BACKGROUND OF THE INVENTION

A. Field of the Invention

The present invention relates to a lookup engine for a network device, especially to a lookup engine which can select an identity independent distribution (I.I.D.) hash function for looking up an address table, thereby to search the address table more efficiently.

B. Description of the Related Art

To improve the speed of address lookup, a new route caching scheme for a layer-4 network device is discussed in “A Novel Cache Architecture to Support Layer-Four Packet Classification at Memory Access Speeds”, INFOCOMM 2000, by Jun Xu et al. The new route caching scheme proposes a dynamic set-associative scheme based on a novel statistically independent parallel hashing scheme. The hardware design of Xu's route cache is especially for layer-4 lookup request. It includes a regular N-way set-associative scheme, in which the N hash functions h₁, h₂, . . . , h_{N} satisfy the following property. Given a random hash key X, h₁(x), h₂(x), . . . , h_{N} (x) are identical independent uniformly distributed random variables.

Refer to FIG. 1, when a lookup request arrives, the 97-bit layer-4 address <DA,SA,DP,SP,PRO> 101 in the request will be processed by N different hardware hash functions 102 in parallel to produce N r-bit hash values and (97-r)-bit tags. The output of the hardware hashes 102 is sent to N independent SLDRAM (Synchronize Link Dynamic Random Access Memory) banks 103. The tag fields in each cache entry will be compared with the tag values output from the hardware hash functions 102 in parallel. If one entry matches, there is a hit and its “next-hop” field will be output as the final “next-hop” result from the multiplexer 105. In contrast, a lookup miss will be processed by a replacement logic 106.

The advantage of the Xu's caching scheme is that the chance of collision can be efficiently reduced. However, Xu did not disclose the implementation of how to select an identity independent distribution (I.I.D.) hash function from the matrix defined over GF(2) and each hash function is uniquely corresponding to such a matrix.

### SUMMARY OF THE INVENTION

It is a primary object of the invention to provide a simple and efficient lookup engine for a network device using an identity independent distribution (I.I.D.) hash function for looking up an address table.

It is another object of the present invention to provide a lookup engine for a network device which can support layer-4 packet forwarding mechanism.

It is still another object of the invention to provide a hashing mechanism that is easy to implement for selecting an I.I.D. hash function, thereby to reduce the chance of collisions and lookup an address table more efficiently.

Accordingly, an aspect of the invention provides a lookup engine for a network device that includes a parser for getting address information of an incoming packet. A predetermined number of shift control logic is provided for generating an I.I.D hash index for the incoming packet in response to the address information of the incoming packet. The output of each shift control logic is selected by a selector for looking up an address table, thereby to generate a forwarding information.

Another aspect of the invention provides a method for generating lookup information for a network device. The method includes the steps of: first, get address information from a header portion of an incoming packet. And then, partition the network address of m bits into a plurality of segments Sᵢ each having n bits, 0≦i<┌m/n┐−1. And generate an I.I.D. hash index by performing XOR operation on a segment S_{base} and a segment S_{extend}, where the segment S_{base} is formed by performing XOR operation on each of the plurality of segments, and the segment S_{extend} is formed by Rotating S₀ a number of bits determined by a predetermined key number. After that, search an address table by using the I.I.D. hash index to generate forwarding information.

### BRIEF DESCRIPTION OF THE DRAWINGS

These and other objects and advantages of the present invention will become apparent when considered in view of the following description and accompanying drawings wherein:

FIG. 1 is a schematic diagram showing the cache scheme of a prior art.

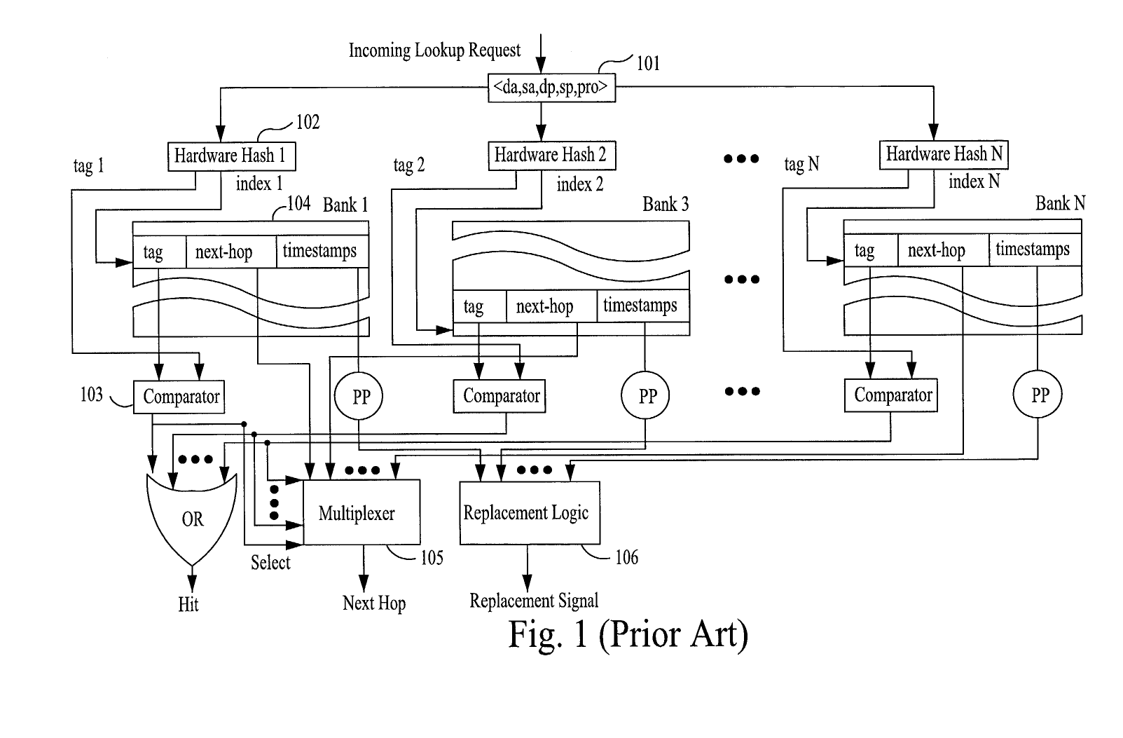

FIG. 2 is a functional block diagram showing the architecture of the lookup engine for a network device according to a preferred embodiment of the present invention.

FIG. 3 is a functional block diagram showing the multi-way hashing mechanism for looking up the flow table according to a preferred embodiment of the present invention.

FIG. 4 is a flowchart showing the operations of the shift control logic according to the preferred embodiment of the present invention.

### DETAIL DESCRIPTION OF THE INVENTION

To solve the conventional hash collision problem and provide a lookup mechanism adaptable to a network device that can support layer-4 service, the invention provides a simple hardware implementation of a hashing mechanism which can select a hash function with I.I.D. characteristics, thereby to lookup the address table more efficiently. The hashing mechanism is adaptable to any network device that requires a table management, such as layer-2, layer-3, and layer-4 switch, router, or bridge for generating a forwarding decision.

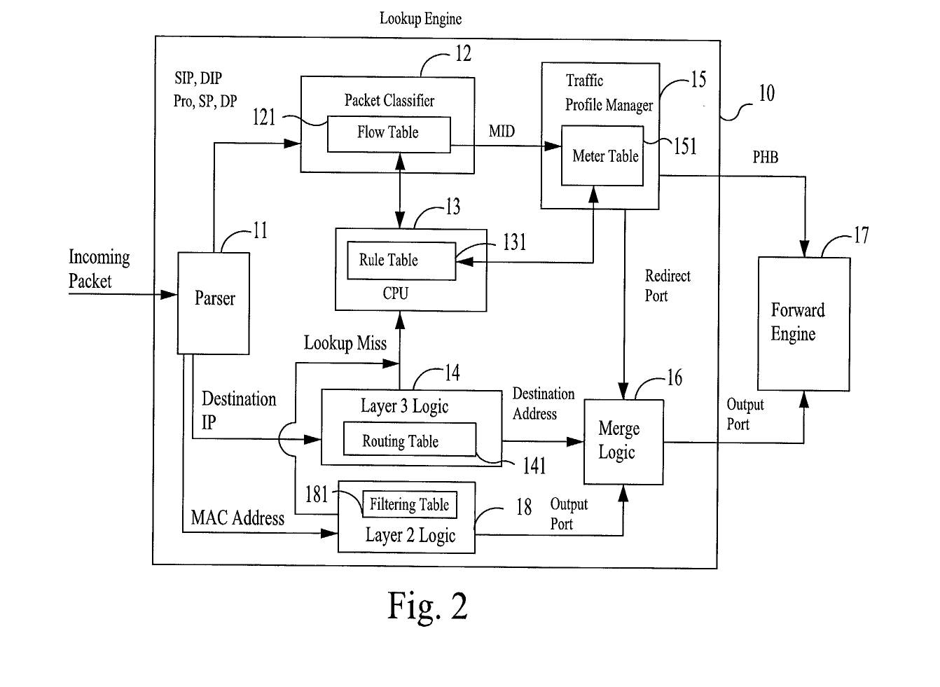

Refer to FIG. 2 for showing a general architecture of a lookup engine 10 for a network device that supports layer-4 service. For layer-4 service, an incoming packet is transmitted to the lookup engine 10 for making a forwarding decision. The header portion of the incoming packet is being analyzed by the parser 11 to provide the header information requested by the Packet classifier 12, the layer-3 logic 14 and the layer-2 logic 18 respectively. The part of the layer-2 and layer-3 forwarding engine architecture is well known to the arts. For layer-3 service, the parser 11 forwards the destination IP of the incoming packet to the layer-3 Logic 14 for looking up the routing table 141 which causes the routing table 141 to output the destination address. The output port information is then sent to the Merge logic 16. For layer-2 service, the MAC address of an incoming packet is forwarded to the layer-2 logic 18 for looking up an associated output port in the filtering table 181. The output port is also sent to the Merge logic 16. The Merge logic 16 uses the information of the output port to instruct the input port what to do with the packet and then send output port information to a forwarding engine 17. Any lookup miss will be sent to the Central Process Unit (CPU) 13 for further processing.

The CPU 13 maintains a rule table 131 for service differentiation, packet filtering, policy routing, traffic rate limiting, accounting and billing. The rule table 131 may be defined by the system/network administrator or downloaded from some policy server. The data structure of the rule table 131 includes source IP address, source IP address mask, destination IP address, destination IP address mask, source port range, destination port range, protocol ID, allowed input rate, Per-hop behavior (PHB), and next hop. Each rule may contain more than one flow. The examples of rules given below are only provided for illustration, and not for limiting the scope of the invention. For instance:

Rule 1 (Service Differentiation): Packets from subnet 1.2.3.x should receive EF PHB.

Rule 2 (Packet Filtering): Deny all packets from 4.5.6.x destined to 7.8.9.x.

Rule 3 (Policy Routing): Send all voice-over-IP packets arriving from 10.2.3.x and destined to 20.4.5.6 via a separate ATM network.

Rule 4 (Accounting & Billing): Treat all video traffic to 80.90.100.200 as highest priority and perform accounting for the traffic sent this way.

Rule 5 (Traffic Rate Limiting): Ensure that subnet 30.7.8. does not inject more than 5 Mbps of email traffic and 20 Mbps of total traffic.

As a packet is incoming to the lookup engine 10, the header information of the incoming packet will be used as a flow address for looking up the flow table 121 of the Packet classifier 12. For any new arrival of the incoming packet, the packet will lead to a flow table lookup miss. Then, the packet is passed to CPU 13 for further packet classification based on the collection of rules defined in the rule table 131. A CPU-based algorithm should have been implemented to classify the incoming packets.

Each packet incoming to the CPU 13 will match one of the previously defined rules. Each rule specifies a class that a packet may belong to, such as Per-Hop Behavior (PHB). Based on the specified class, the packet is forwarded accordingly. In the mean time, CPU 13 creates a new entry in the flow table 121 for the incoming packets of that flow. In a preferred embodiment, the Packet classifier 12 is capable of “Auto-learning”. That is, the Packet classifier 12 will learn the forwarding behavior of CPU 13, such as PHB selection, and record it onto the flow table 121.

The packet classifier 12 uses the header information provided by the parser 11 to form a flow address for looking up the flow table 121. A “flow” is a single instance of an application-to-application flow of packets which is identified by the bit-combination of the source IP (SIP), destination IP (DIP), protocol (PRO), source port (SP), and destination port (DP) information. The flow table 121 records the information of source IP address, destination IP address, source port, destination port, protocol ID, and rule index for generating an associated Meter ID (MID) for the incoming packet.

Some examples of flows are shown as follows for the purpose of illustration:

Flow-1: Packets from IP 1.2.3.4, port 1500 to IP 100.2.3.4, port 150, are a flow that fits the Rule-1, occupying an entry of Flow Table 121.

Flow-2: Packets from IP 1.2.3.8, port 2500 to IP 200.2.3.4, port 250 are also a flow in the class of expedited forwarding (EF).

The Traffic Profile Manager 15 maintains a meter table 151. The data structure of the meter table 151 includes token bucket, allowed input rate, last time update entry, token enough PHB, Token not enough PHB, and token not enough next hop. The meter table 151 records the on-line traffic statistics and the traffic parameters for making the decision of whether the flow traffic meets the profile or not. The meter table 151 also records the actions for in-profile and out-of-profile packets, respectively. The meter table 151 will output a forwarding decision to the forwarding decision 17 in response to the meter table ID output from the flow table 12. The meter table 151 may also output a redirect port decision to the Merge Logic 16. Based on the above examples, both Flow-1 and Flow-2 should meet the traffic profile defined by Rule-1. Any lookup miss will also be sent to CPU 13 to process.

The lookup engine 10 involves the mechanism for looking up address tables, including but not limiting to flow table 121, meter table 151, routing table 141 and filtering table 181. Take the flow table 121 lookup for an example, the invention provides a hashing mechanism that can select an I.I.D. hash function for searching the flow table 121 more efficiently. Refer to FIG. 2 for showing the hashing mechanism according to the preferred embodiment of the invention. The hashing mechanism can translate the universe of hash keys into addresses more randomly and uniformly.

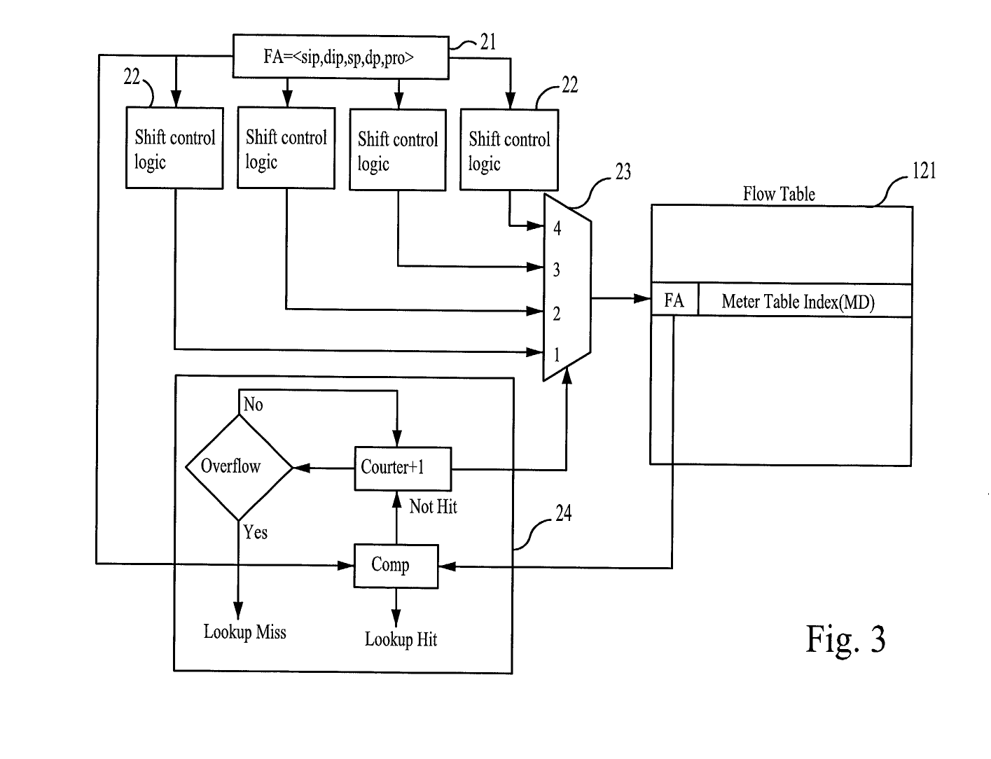

Refer to FIG. 3, the flow table 121 is for caching flow information for individual end-to-end flows. Each entry in the flow table 121 corresponds to a flow with a fully specified filter (one that contains no wildcards). Since there is no wildcarding, hashing operation can be performed more efficiently for implementing the flow table 121.

To provide a hash function with I.I.D. characteristics, the invention applies a mathematically proved I.I.D. matrix, proposed by L. Carter and M. Weginan,(“Universal Classes of Hashing Functions,” J. Computer and System Sciences, vol. 18, no. 2, pp. 143-154, 1979.) for generating a plurality of I.I.D. hash functions. Accordingly, the I.I.D. hash functions can be generated by multiplying the flow address <SIP, DIP, SP, DP, PRO> with the I.I.D. matrix.

The I.I.D. matrix can be expressed as follows:

$$[ \begin{matrix}{b}_{0} \\ {b}_{1} \\ ⋮ \\ {b}_{n - 1}\end{matrix} ] = [ \begin{matrix}{q}_{0 , 0} & {q}_{0 , 1} & … & {q}_{0 , m - 1} \\ {q}_{1 , 0} & {q}_{1 , 1} & … & {q}_{1 , m - 1} \\ ⋮ & ⋮ & ⋰ & ⋮ \\ {q}_{n - 1 , 0} & {q}_{n - 1 , 1} & … & {q}_{n - 1 , m - 1}\end{matrix} ] \times [ \begin{matrix}{a}_{0} \\ {a}_{1} \\ ⋮ \\ {a}_{m - 1}\end{matrix} ]$$

where B represents the hash index of n bits, Q represents the set of all possible n×m matrices, T the transposition, and A the flow address of m bits. Accordingly, each hash function is a linear transformation B^{T}=QA^{T} that maps a m-bit binary stream A=a₀a₁ . . . aₘ₋₁ to an n-bit binary stream B=b₀b₁ . . . bₙ₋₁.

Here a k-bit stream is treated as a k-dimensional vector over GF(2)={0, 1}. Q is an n×m matrix defined over GF(2) and each hash function is uniquely correspondent to such a matrix Q. The multiplication and addition in GF(2) is performed by boolean AND (denoted as &) and XOR (denoted as ⊕), respectively. Thus, each bit of B is calculated as:

bᵢ=(a₀&q_{i,0})⊕(a₁&q_{i,1})⊕ . . . ⊕(aₘ₋₁&q_{i,m-1}), i=0, 1, 2, . . . , n−1.

Let Q denote the set of all possible n×m matrices, where n represents the size of the flow table with 2ⁿ entries and m represents the number of flow address with m bits. Let Qₕ ε Q be the desirable set of matrices and 0≦h≦n−1 (The index h referred to as the hash function selector.). Furthermore, let qᵢⱼ denote the element of Qₕ, where i represents the row number and j represents the column number (0≦i≦n−1 and 0≦j≦m−1). Then, under the condition that

When j<n,

qᵢⱼ=1, if j is equal to (i+h) mod n,

qᵢⱼ=0, otherwise;

When j>n,

qᵢⱼ=1 if i is equal to j mod n,

qᵢⱼ=0, otherwise;

an I.I.D. hash function can be selected from the I.I.D. matrix. Thus, based on the definition of q_{i,j}, bᵢ=a_{(i+h)%n}⊕aᵢ₊ₙ ⊕aᵢ₊ₙ . . . , wherein i=0, 1, 2, . . . , n−1.

According to such a condition, given a random hash key X or a flow address, the multi-way (N) hash functions h₁(x), h₂(x), . . . , h_{N}(x) are identical independent distributed (I.I.D) random variables. That is, each hash index, such as h₁(X), can be viewed as a memory location of the flow table 121. Given a specific flow address, those generated hash indexes are “definitely” different. To illustrate the I.I.D. characteristics of the hash keys more clearly, take a 5×19 Q matrix for an example, where the hash function selector h is chosen to be 2. Then, Q₂ is calculated and shown as below:

$$[ \begin{matrix}0 & 0 & 1 & 0 & 0 \\ 0 & 0 & 0 & 1 & 0 \\ 0 & 0 & 0 & 0 & 1 \\ 1 & 0 & 0 & 0 & 0 \\ 0 & 1 & 0 & 0 & 0\end{matrix} \vert \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} \vert \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} \vert \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ]$$

The resultant matrix yields a random distribution for the flow addresses. And, all of the row vectors of Qₕ's are linearly independent. After the matrix selection (Qₕ) procedure described above is formed, there is no further matrix-related operations.

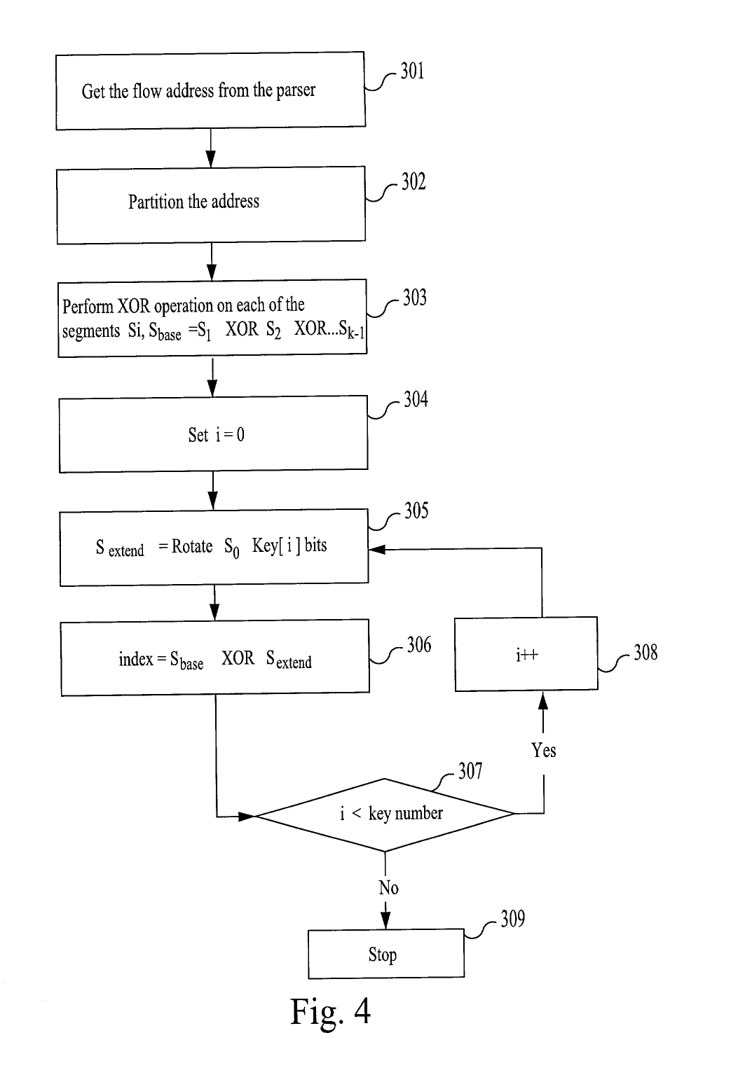

The hardware implementation of the above method can be easily accomplished by a plurality of shift control logic 22. The shift control logic 22 includes a shift register and a plurality of XOR logic gates. Refer to FIG. 4 for showing the operation of the shift control logic 22. According to the preferred embodiment of FIG. 3, each flow address is hashed four times by the four shift control logic 22. In other words, each flow address can access the flow table 121 four times at the most for the concern of the time-space tradeoff.

First, get the flow address 21 of m bits from the parser 11, step 301. And then, partition the flow address 21 into k segments Sᵢ, 0≦i<┌m/n┐−1. Each of the segments Sᵢ contains n bits that represent a 1×n matrix. If there is a remainder bits in the last segment, then fill the rightmost bits of the last segment S_{┌m/n┐} with zeros, step 302. After that, perform binary XOR operation on each of the segments Sᵢ while shifting the segments Sᵢ a number of times determined by the predetermined number of hash keys, step 303. That is, h-bit of S₀ (in this case, 4 bits) is rotated and shifted to right first each time after the XOR operation. The hash index (indexₕ) for each hash function selector is then generated; that is, indexₕ=S₀⊕S₁ . . . ⊕S_{(┌m/n┐-1)}. Let the hash index S_{base}=S₁ XOR S₂ XOR . . . Sₖ₋₁. Since any flow address A can be represented as a₀, a₁, a₂, . . . , aₘ, the segment of S_{base} can be represented as S_{base,i}. Accordingly, S_{base,i}=aₙ₊ᵢ⊕a₂ₙ₊ᵢ⊕ . . . .

Step 304˜Step 311 are for the rotation and shift of the h-bit of S₀ for generating each I.I.D. hash index. Step 304: Set the counter i=0. Then, generate a new segment by setting S_{extend}=Rotate S₀ Key[i] bits, step 305. The element of S_{extend} can be represented as S_{extend,i}. Then, S_{extend,i}=a_{(i+h) mod n} based on the operation of rotation. And then, generate the I.I.D. hash index by performing XOR operation on S_{base} and S_{extend}. Indexₕ=S_{base} XOR S_{extend}, step 306. As the computation result of Indexₕ, the element of Indexₕ can be represented as Index_{h,i}. Thus, Index_{h,i}=a_{(i+h) mod n} ⊕ aₙ₊ᵢ ⊕ a₂ₙ₊ᵢ ⊕ . . . . Accordingly, it shows that the rotation and XOR result is equal to the matrix operation.

And check if i<key number, step 307. If yes, go to step 308 to increment i by one, and then go to step 305. Repeat these steps until 4 hash keys have been generated, and then go to step 309: to stop.

The four hash keys generated by the shift control logic 22 are sequentially selected by the selector 23 in response to the comparator logic 24 until an empty entry is found. The comparator logic 24 sequentially checks if the entry of the flow table 121 indexed by the current hash index is an empty slot. If yes, the entry is taken. If not, the comparator logic 24 sends a control signal to the selector 23 to select next available hash key 22. The process repeats until each hash index 22 has been selected. If no empty slot is found after the first round of the hash index, the lookup miss information is sent to the CPU 13 to process the incoming packet.

Accordingly, when a lookup request arrives, the 104-bit flow address 21 in the request will be used to generate n-bit hash index. For example, if the value of n is 16, then the size of flow table is 64K (2ⁿ=2¹⁶). Intuitively, such a hash mapping (104-bit→16-bit) will lead to high possibility of collision, when comparing to that of the IP address hashing approach (32-bit→16-bit). However, since the invention uses the I.I.D. matrix described above, the chance of hash collision has been reduced to the minimum.

To sum up, the hash function selected by the invention can guarantee an identity independent distribution on the search table for insertion and table lookup. Thus, the invention can use the memory more efficiently and access the memory as fast as the Layer-3 logic and Layer-2 logic so that they can finish their jobs together within the same cycle time. Accordingly, the lookup engine can construct each flow entry and classify the incoming packets belonging to this flow in wire-speed.

It should be understood that various alternatives to the method and architecture described herein may be employed in practicing the present invention. It is intended that the following claims define the invention and that the structure within the scope of these claims and their equivalents be covered thereby.

What is claimed is:

1. A lookup engine for a network device, comprising the steps of:
a parser for getting address information of an incoming packet;
a predetermined number of shift control logic each for generating an Identity Independent Distribution (I.I.D) hash index for said incoming packet in response to said address information of said incoming packet; and
a selector for selecting an I.I.D. hash index from said predetermined number of shift control logic, and said selected I.I.D. hash index causes an address table to output forwarding information for said incoming packet.

2. The lookup engine as claimed in claim 1, further comprising:
a central process unit for processing said incoming packet when said I.I.D. hash indexes find no hit in said address table.

3. The lookup engine as claimed in claim 1, wherein said network address is a destination MAC address.

4. The lookup engine as claimed in claim 1, wherein said network address is a destination IP address.

5. The lookup engine as claimed in claim 1, wherein said network address is a flow address.

6. The lookup engine as claimed in claim 1, wherein said shift control logic comprises:
a shift register having a plurality of segments for shifting said plurality of segments in response to a predetermined key number; and
means for performing XOR operations on said plurality of segments.

7. A method for generating lookup information for a network device, comprising the steps of:
getting address information from a header portion of an incoming packet;
partitioning said network address of m bits into a plurality of segments Sᵢ each having n bits,
$$0 \leq i < ⌈ \frac{m}{n} ⌉ - 1 ;$$
generating an I.I.D. hash index by performing XOR operation on a segment S_{base} and a segment S_{extend}, where said segment S_{base} is formed by performing XOR operation on each of said plurality of segments, and said segment S_{extend} is formed by Rotating S₀ a number of bits determined by a predetermined key number; and
searching an address table by using said I.I.D. hash index to generate forwarding information.

8. The method as claimed in claim 7, further comprising the step of:
obtaining said segment
$${S}_{⌈ \frac{m}{n} ⌉}$$
to have the same length with said segment S₀ by filling binary zeros.

9. The method as claimed in claim 7, wherein said address information is a flow address and said address table is a flow table.

10. The method as claimed in claim 7, wherein said address information is a destination IP address and said address table is a routing table.

11. The method as claimed in claim 7, wherein said address information is a MAC address and said address table is a filtering table.

12. The method as claimed in claim 7, further comprising the step of:
forwarding said incoming packet to a processor when said I.I.D. hash index having no hit in said address table.
